(19) United States
(12) Patent Application Publication
(10) Pub. No.: US 2021/0387635 A1
(43) Pub. Date: Dec. 16, 2021

(54) VEHICLE PERIPHERAL MONITORING APPARATUS AND METHOD THEREOF

(71) Applicant: Faurecia Clarion Electronics Co., Ltd., Saitama (JP)

(72) Inventor: Takashi HARAGUCHI, Saitama (JP)

(21) Appl. No.: 17/235,347

(22) Filed: Apr. 20, 2021

(30) Foreign Application Priority Data
Jun. 15, 2020 (JP) 2020-102986

(51) Int. Cl. B60W 60/00; B60W 50/14; B60W 40/02

(52) U.S. Cl. CPC B60W 60/001; B60W 50/14; B60W 2554/4046; B60W 2556/65; B60W 40/02

(57) ABSTRACT

A vehicle peripheral monitoring apparatus includes an autonomous driving level that recognizes an autonomous driving level of another vehicle present around a subject vehicle, a driver condition acquisition part that acquires a driver condition of said another vehicle, a storage that stores autonomous driving levels and acceptable driver conditions in association with each other, a determination part that compares the acceptable driver condition, which is stored in the storage, at the autonomous driving level recognized by the autonomous driving level recognition part with the driver condition of said another vehicle acquired by the driver condition acquisition part, in order to determine whether or not the driver condition of said another vehicle is acceptable, and a notification part notifies a warning to a driver of the subject vehicle when the determination part determines that the driver condition of said another vehicle is not acceptable.

### CROSS-REFERENCE TO RELATED APPLICATION

The present application is based on and claims a priority benefit of Japanese patent application No. 2020-102986, filed on Jun. 15, 2020, the disclosure of which is hereby incorporated herein by reference in its entirety.

### BACKGROUND

This disclosure relates to a vehicle peripheral monitoring apparatus and a vehicle peripheral monitoring method.

WO2018/092265A1 discloses a driving assistance apparatus including: a posterior-driver state identifying unit which identifies a driving state of a driver of a following vehicle based on a rear image of a subject vehicle; a peripheral-circumstance determining unit which determines circumstances around the subject vehicle based on images around the subject vehicle including the rear image; and an autonomous driving unit which controls autonomous driving of the subject vehicle based on the driving state identified by the posterior-driver state identifying unit and the circumstances determined by the peripheral-circumstance determining unit. The posterior-driver state identifying unit identifies the driving state of the driver of the following vehicle by determining, through pattern matching, a face orientation of the face of the driver of the following vehicle and whether eyes of the driver of the following vehicle are open or close, and upon determining that the following vehicle is in a dangerous driving state, notifies a driver of the subject vehicle of the dangerous driving state. Upon determination that the following vehicle is in the dangerous driving state, the autonomous driving unit controls the autonomous driving based on the circumstances determined by the peripheral-circumstance determining unit so that a collision against the following vehicle is avoided.

### SUMMARY

With the driving assistance apparatus disclosed in WO2018/092265A1, the apparatus notifies the driver of the subject vehicle of the dangerous driving state when the driver of the following vehicle is looking aside, for example. However, if the autonomous driving level of the following vehicle is relatively high, it may not be appropriate to determine that the following vehicle is in the dangerous driving state.

The present disclosure has been made in view of the above circumstances, and an object of this disclosure is, therefore, to provide a vehicle peripheral monitoring apparatus and a vehicle peripheral monitoring method capable of appropriately notifying a driver of the subject vehicle about a driving condition of a driver of another vehicle in accordance with an autonomous driving level of said another vehicle traveling around the subject vehicle.

An embodiment of a vehicle peripheral monitoring apparatus described in this disclosure comprises: an autonomous driving level recognition part configured to recognize an autonomous driving level of another vehicle present around a subject vehicle; a driver condition acquisition part configured to acquire a driver condition of said another vehicle; a storage configured to store autonomous driving levels and acceptable driver conditions in association with each other; a determination part configured to compare the acceptable driver condition, which is stored in the storage, at the autonomous driving level recognized by the autonomous driving level recognition part with the driver condition of said another vehicle acquired by the driver condition acquisition part, in order to determine whether or not the driver condition of said another vehicle is acceptable; and a notification part configured to notify a warning to a driver of the subject vehicle when the determination part determines that the driver condition of said another vehicle is not acceptable.

An embodiment of a vehicle peripheral monitoring method described in this disclosure comprises: recognizing an autonomous driving level of another vehicle present around a subject vehicle; acquiring a driver condition of said another vehicle; storing autonomous driving levels and acceptable driver conditions in association with each other; comparing the stored acceptable driver condition at the recognized autonomous driving level with the acquired driver condition of said another vehicle in order to determine whether or not the driver condition of said another vehicle is acceptable; and notifying a warning to a driver of the subject vehicle when it is determined that the driver condition of said another vehicle is not acceptable.

### BRIEF DESCRIPTION OF DRAWINGS

FIG. 1 is a block diagram showing an example of a vehicle peripheral monitoring apparatus in accordance with an embodiment of this disclosure.

FIG. 2 is a block diagram showing a detailed configuration of a following vehicle driving state determination part of FIG. 1.

FIG. 3 is a flowchart showing processes of the vehicle peripheral monitoring apparatus of FIG. 1 and FIG. 2.

FIG. 4 is a table showing an example of autonomous driving guidelines which define correspondences between the autonomous driving levels, acceptable driver conditions, and ODDs.

### DETAILED DESCRIPTION

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

Hereinafter, an embodiment of a vehicle peripheral monitoring apparatus in accordance with this disclosure will be described with reference to the drawings.

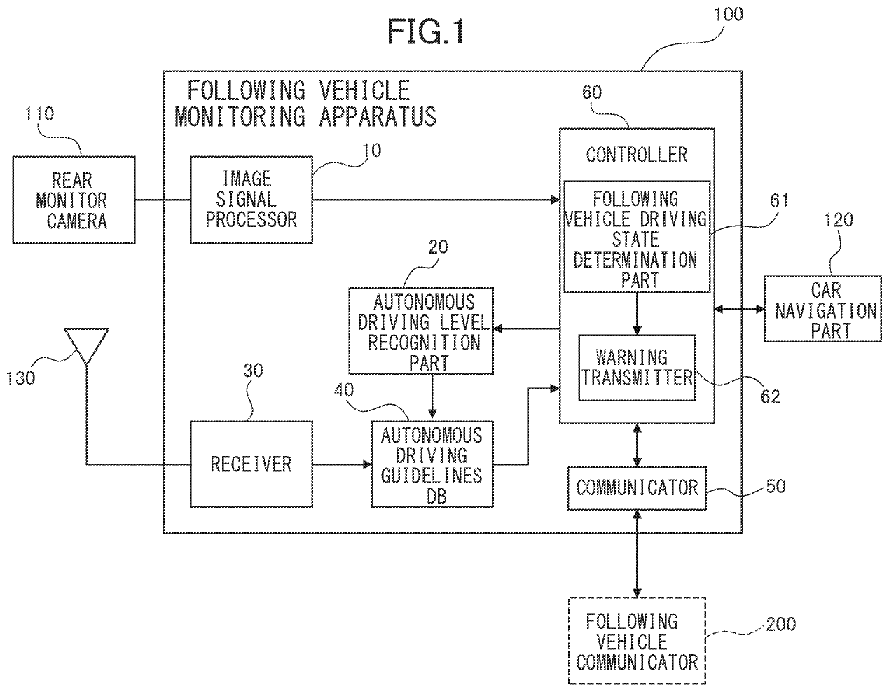

FIG. 1 shows an embodiment of a following vehicle monitoring apparatus 100 in accordance with this disclosure. The following vehicle monitoring apparatus 100 is an embodiment of the vehicle peripheral monitoring apparatus of this disclosure and is provided in a vehicle (subject vehicle) to monitor other vehicles around the subject vehicle that travel mainly behind the subject vehicle. Optionally, the following vehicle monitoring apparatus 100 may monitor any other vehicles traveling around the subject vehicle, such as the left-and-right sides, the left-and-right rear sides, the front side, and the left-and-right front sides of the subject vehicle. The “other vehicles” herein may mean a single or several vehicles.

The following vehicle monitoring apparatus 100 includes an autonomous driving level recognition part 20, a driver condition acquisition part, a storage, a determination part, and a notification part.

The autonomous driving level recognition part 20 is configured to recognize an autonomous driving level of another vehicle (e.g., following vehicle) traveling behind the subject vehicle.

The autonomous driving level recognition part 20 receives or acquires a signal (autonomous driving level signal) indicative of the autonomous driving level of said another vehicle (e.g., following vehicle) by a communicator 50 of the following vehicle monitoring apparatus 100. The autonomous driving level signal is output from a communicator 200 of said another vehicle. The autonomous driving level recognition part 20 then recognizes the autonomous driving level of said another vehicle based on the autonomous driving level signal input through a controller 60.

The controller 60 includes an arithmetic element represented by an integrated circuit, such as a programmable logic device and an Application Specific Integrated Circuit (ASIC). An example of such a programmable logic device includes a Central Processing Unit (CPU) and a Field-Programmable Gate Way (FPGA).

The autonomous driving level is determined based on the performance of the autonomous driving and is set in, for example, 5 stages from 1 to 5. Level 1 is a stage in which the degree of realization of the autonomous driving is lowest, and the level increases as the degree of realization of the autonomous driving increases.

The autonomous driving level of another vehicle is acquired and recognized through a vehicle-to-vehicle communication, i.e., the communicator 200 of said another vehicle outputs a signal indicative of the autonomous driving level of said another vehicle, and the communicator 50 of the subject vehicle receives the signal. However, the acquisition and recognition of the autonomous driving level are not limited thereto. For example, the autonomous driving level recognition part 20 may recognize the autonomous driving level of another vehicle using a rear monitor camera 110 installed in the subject vehicle. That is, the rear monitor camera 110 may read an indicator of the autonomous driving level of said another vehicle. Alternatively, the rear monitor camera 110 may identify a vehicle type and model year of said another vehicle and refer to the identified information of said another vehicle recorded on the database (DB) of the autonomous driving vehicles in order to determine the autonomous driving level of said another vehicle.

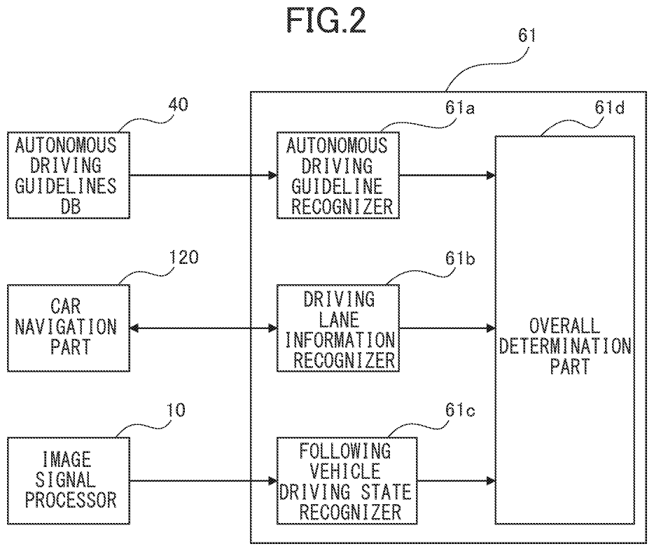

The driver condition acquisition part is configured to acquire a driver condition of another vehicle (e.g., following vehicle), and includes an image signal processor 10 and a following vehicle driving state recognizer 61c (shown in FIG. 2) of the following vehicle driving state determination part 61 of the controller 60. The image signal processor 10 acquires an image (image signal) of the following vehicle captured by the rear monitor camera 110, which is installed in the subject vehicle to monitor a following vehicle, and performs signal processing on the image signal.

As the driving state, the driver condition acquisition part acquires, for example: (i) whether or not the driver is sleeping; (ii) when the driver is not sleeping (i.e., when the eyes of the driver are open), whether or not the hands of the driver are off from the steering wheel (e.g., driver is using a smartphone); and (iii) when the driver is holding the steering wheel, whether or not the driver is looking aside (i.e., whether or not the driver is not looking forward, but sideways, backward, or downward).

The storage stores, for example, the autonomous driving level and the driver condition, which is allowed or acceptable at each autonomous driving level, in association with each other, and includes an autonomous driving guidelines database (DB) 40. The autonomous driving guidelines DB 40 stores an autonomous driving guideline which is received by a receiver 30 from an external server via an antenna 130 installed in the subject vehicle.

The receiver 30 receives the autonomous driving guidelines, for example, each time the subject vehicle starts (i.e., each time the ignition switch is turned ON).

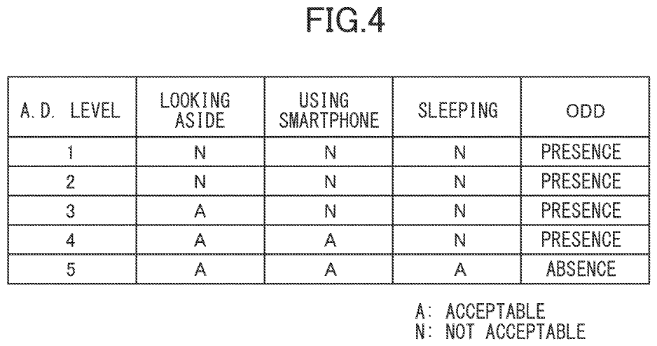

The autonomous driving guideline received by the receiver 30 defines correspondences between the autonomous driving levels 1 to 5 and the driver conditions allowed at the respective autonomous driving levels (A.D. Levels). FIG. 4 shows an example of the correspondences.

In an example of the autonomous driving guidelines shown in the table of FIG. 4, neither sleeping, using a smartphone, nor looking aside is acceptable as the driver condition at the autonomous driving level 1.

In this embodiment, looking aside is only an example of a condition in which the driver's line of sight is off the forward. Similarly, using a smartphone is only an example of a condition in which the hands of the driver are not on the steering wheel, and sleeping is only an example of a condition in which the driver's consciousness does not instantly return to a concentrated state that is required for driving.

In addition to the driver conditions described above, the autonomous driving guidelines include the presence or absence of an Operational Design Domain (ODD). That is, it is also determined whether or not the driving environment of the subject vehicle is within a predetermined area or range when the ODD is present.

In the autonomous driving guidelines shown in the table of FIG. 4, neither sleeping, using a smartphone, nor looking aside is acceptable as the driver condition at the autonomous driving level 2. As shown, the acceptable driver conditions between the autonomous driving level 1 and the autonomous driving level 2 in the autonomous driving guidelines are identical to each other but are different in the hardware that assists the autonomous driving.

In the autonomous driving level 1, the autonomous driving system assists one of the steering operation or the acceleration of the vehicle. In the autonomous driving level 2, the autonomous driving system assists both the steering operation and the acceleration of the vehicle.

In the autonomous driving guidelines shown in the table of FIG. 4, neither sleeping nor using a smartphone is acceptable but looking aside is acceptable as the driver condition at the autonomous driving level 3.

In the autonomous driving guidelines shown in the table of FIG. 4, sleeping is not acceptable but using a smartphone and looking aside are acceptable as the driver condition at the autonomous driving level 4.

In the autonomous driving guidelines shown in the table of FIG. 4, all of sleeping, using a smartphone, and looking aside are acceptable as the driver condition at the autonomous driving level 5. As shown therein, the ODD is set at the autonomous driving levels 1 to 4, but not at the autonomous driving level 5. That is, the autonomous driving level 5 realizes the autonomous driving that allows the driver to sleep, to use a smartphone, and to look aside under any environment.

The autonomous driving guidelines DB 40 stores the autonomous driving guidelines, which are input by the receiver 30, and receives an input of the autonomous driving level of the following vehicle recognized by the autonomous driving level recognition part 20.

The autonomous driving guidelines DB 40 then selects, from the five autonomous driving levels stored therein, the autonomous driving level that corresponds to the autonomous driving level of the following vehicle input from the autonomous driving level recognition part 20, and outputs the presence or absence of the ODD and the acceptable driver conditions defined in the autonomous driving guidelines associated with the selected autonomous driving level to an autonomous driving guideline recognizer 61a (shown in FIG. 2) of the following vehicle driving state determination part 61.

The determination part is configured to determine whether or not the driver condition of another vehicle is acceptable by comparing the acceptable driver conditions, which are stored in the storage (autonomous driving guidelines DB 40) in association with the autonomous driving level recognized by the autonomous driving level recognition part 20, with the driver condition acquired by the driver condition acquisition part (image signal processor 10). The determination part includes an overall determination part 61d of the following vehicle driving state determination part 61 of the controller 60.

As shown in FIG. 2, the following vehicle driving state determination part 61 includes the autonomous driving guideline recognizer 61a, a driving lane information recognizer 61b, the following vehicle driving state recognizer 61c, and the overall determination part 61d.

The autonomous driving guideline recognizer 61a is configured to read out the autonomous driving guideline stored in the autonomous driving guidelines DB 40 and to recognize the driver conditions associated with the corresponding autonomous driving level and the contents of ODD if the ODD is present.

The driving lane information recognizer 61b recognizes or determines whether or not the driving lane in which the subject vehicle is traveling corresponds to the ODD associated with the selected autonomous driving level based on positional information of the subject vehicle input through a car navigation part 120 installed in the subject vehicle. For example, when the ODD determined in accordance with the autonomous driving level is an automobile-only road (e.g., expressway or other specialized roads equivalent to expressway), the driving lane information recognizer 61b recognizes or determines whether or not the driving lane in which the subject vehicle is traveling is an automobile-only road.

As described above, the following vehicle driving state recognizer 61c recognizes the following conditions based on the processed image signal input from the image signal processor 10: (i) whether or not the driver is sleeping; (ii) when the driver is not sleeping (i.e., when the eyes of the driver are open), whether or not the hands of the driver are off from the steering wheel (e.g., driver is using a smartphone); and (iii) when the driver is holding the steering wheel, whether or not the driver is looking aside (i.e., whether or not the driver is not looking forward, but sideways, backward, or downward).

The overall determination part 61d determines whether or not the driver condition of the following vehicle is acceptable under the autonomous driving guidelines at the recognized autonomous driving level of the following vehicle based on the driver condition recognized by the following vehicle driving state recognizer 61c (i.e., condition (i), (ii), or (iii)) and the driving lane recognized by the driving lane information recognizer 61b.

A notification part is configured to send a notification or a warning to the driver of the subject vehicle and to the communicator 200 of the following vehicle when it is determined by the determination part that the driver condition of the following vehicle is not acceptable under the autonomous driving guideline at the autonomous driving level of the following vehicle.

The notification part includes a warning transmitter 62 and the communicator 50. The warning transmitter 62 is provided to the following vehicle monitoring apparatus 100 and transmits a warning that the driver condition of the following vehicle is not acceptable to the driver of the subject vehicle. The communicator 50 is configured to transmit a similar warning to the communicator 200 of the following vehicle.

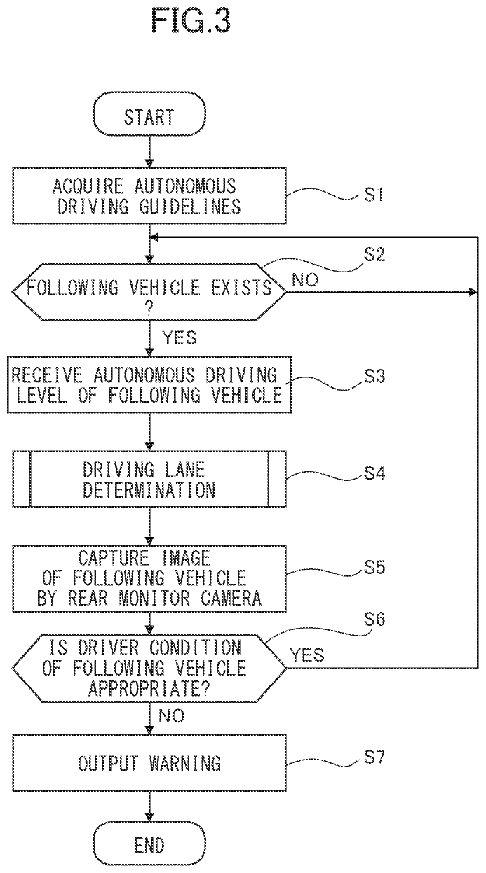

The operations of the following vehicle monitoring apparatus 100 as configured above will be described with reference to FIG. 3 flowchart.

Upon starting the subject vehicle, the receiver 30 receives or acquires the autonomous driving guidelines and stores them into the autonomous driving guidelines DB 40 (S1).

The controller 60 of the subject vehicle then determines whether or not another vehicle (following vehicle) exists within a preset range (S2). To be specific, the controller 60 determines that a following vehicle exists (i.e., YES in S2) when the communicator 50 acquires an autonomous driving level of the following vehicle from the communicator 200 of the following vehicle through the vehicle-to-vehicle communication. On the other hand, the controller 60 determines that a following vehicle does not exist (i.e., NO in S2) when the communicator 50 does not acquire an autonomous driving level of a following vehicle through the vehicle-to-vehicle communication.

It should be noted that the determination of the existence of a following vehicle (S2) may be realized by, in addition to the abovementioned vehicle-to-vehicle communication, determining whether or not a following vehicle is recognized based on an image captured by the rear monitor camera 110. Alternatively, the determination may be realized by using a sonar device, a radar device, LiDAR, or the like.

When the controller 60 determines that the following vehicle exists, the controller 60 outputs the autonomous driving level received by the communicator 50 (S2 or S3) to the autonomous driving level recognition part 20, such that the autonomous driving level recognition part 20 outputs the autonomous driving level of the following vehicle to the autonomous driving guidelines DB 40.

The autonomous driving guidelines DB 40 compares the input autonomous driving level of the following vehicle with the autonomous driving level in the stored autonomous driving guidelines (FIG. 4) and selects the autonomous driving level in the autonomous driving guidelines that matches with the recognized autonomous driving level of the following vehicle. The autonomous driving guidelines DB 40 then outputs the acceptable driver condition and the ODD associated with the selected autonomous driving level.

Subsequently, the driving lane information recognizer 61b of the following vehicle driving state determination part 61 in the controller 60 receives, for example, a type of the road on which the subject vehicle is traveling, from the car navigation part 120 of the subject vehicle. The driving lane information recognizer 61b then determines the type of the road on which the subject vehicle is traveling (S4). The determined type of the road is input to the overall determination part 61d.

Through the determination of the type of the road and the like, the overall determination part 61d can determine whether or not the driving lane on which the subject vehicle is traveling corresponds to the ODD defined in the autonomous driving guidelines.

With respect to the existing following vehicle, the image signal processor 10 processes the image of the following vehicle input from the rear monitor camera 110 and inputs the processed results to the following vehicle driving state recognizer 61c.

The following vehicle driving state recognizer 61c recognizes the driver condition of the following vehicle based on the processed image signal input from the image signal processor 10. To be specific, the following vehicle driving state recognizer 61c recognizes the driver condition such as whether or not the driver is looking aside based on, for example, a face orientation of the driver; whether or not the driver is using a smartphone or the like based on, for example, whether or not a hand of the driver is touching the steering wheel and the face orientation; and whether or not the driver is sleeping based on, for example, whether or not the eyes of the driver are closed. The following vehicle driving state recognizer 61c then outputs the recognition results to the overall determination part 61d.

The overall determination part 61d determines whether or not the driver condition of the following vehicle is appropriate at the autonomous driving level of the following vehicle based on the acceptable driver condition input from the autonomous driving guideline recognizer 61a, the information input from the driving lane information recognizer 61b such as the type of the road on which the subject vehicle is traveling, and the driver condition of the following vehicle input from the following vehicle driving state recognizer 61c (S6).

To be specific, when the driving lane corresponds to the autonomous driving level of the following vehicle (i.e., when the driving lane of the subject vehicle corresponds to the ODD at the autonomous driving level) and the driver condition of the following vehicle meets the acceptable driver condition, the overall determination part 61d determines that the driver condition of the following vehicle is appropriate (i.e., YES in S6).

On the other hand, when the driving lane does not correspond to the autonomous driving level of the following vehicle or when the driving lane corresponds to the autonomous driving level of the following vehicle but the driver condition of the following vehicle does not meet the acceptable driver condition, the overall determination part 61d determines that the driver condition of the following vehicle is not appropriate (i.e., NO in S6).

When the overall determination part 61d determines that the driver condition of the following vehicle is not appropriate, the warning transmitter 62 outputs a warning to the driver of the subject vehicle and the communicator 50 also sends the warning to the following vehicle (S7). The program then ends.

As described above, the following vehicle monitoring apparatus 100 of this embodiment is configured to output a warning to the driver of the subject vehicle when the driver condition of another vehicle traveling behind the subject vehicle is not appropriate in accordance with the autonomous driving level of said another vehicle and the types of the road (ODD). On the other hand, the following vehicle monitoring apparatus 100 of this embodiment is configured not to output a warning to the driver of the subject vehicle when the driver condition of said another vehicle is acceptable. With this, it is possible to output a warning appropriately.

In this embodiment, the following vehicle monitoring apparatus 100 determines whether or not the driver condition of another vehicle traveling behind the subject vehicle is acceptable in accordance with the autonomous driving level of said another vehicle and the ODD. However, the following vehicle monitoring apparatus 100 may determine whether or not the driver condition of said another vehicle is acceptable in accordance with the autonomous driving level of said another vehicle solely if the following vehicle monitoring apparatus 100 is configured to be activated only when the driving lane of the subject vehicle is within the ODD.

The following vehicle monitoring apparatus 100 of this embodiment is configured to perform the monitoring process such as the acquisition process, the recognition process, and the warning process with respect to only another vehicle traveling behind the subject vehicle. However, the following vehicle monitoring apparatus 100 of this embodiment may be configured to monitor, not only a vehicle behind the subject vehicle, but also vehicles on the left-and-right sides, the left-and-right rear sides, the front side, and the left-and-right front sides of the subject vehicle.

It should be noted that it may be difficult to acquire a driver condition of another vehicle with a monitor camera installed on the subject vehicle. In such a case, the driver condition may be acquired by receiving an image captured by an inner camera of said another vehicle (i.e., target vehicle) through the vehicle-to-vehicle communication. Alternatively, the driver condition may be acquired by receiving an image captured by a monitor camera of a different vehicle traveling in front of the target vehicle through the vehicle-to-vehicle communication.

Although the present disclosure has been described in terms of an exemplary embodiment, it should not be limited thereto. It should be appreciated that variations or modifications may be made in the embodiment described by persons skilled in the art without departing from the scope of the present invention as defined by the following claims.

What is claimed is:

1. A vehicle peripheral monitoring apparatus, comprising:
an autonomous driving level recognition part configured to recognize an autonomous driving level of another vehicle present around a subject vehicle;
a driver condition acquisition part configured to acquire a driver condition of said another vehicle;
a storage configured to store autonomous driving levels and acceptable driver conditions in association with each other;
a determination part configured to compare the acceptable driver condition, which is stored in the storage, at the autonomous driving level recognized by the autonomous driving level recognition part with the driver condition of said another vehicle acquired by the driver condition acquisition part, in order to determine whether or not the driver condition of said another vehicle is acceptable; and
a notification part configured to notify a warning to a driver of the subject vehicle when the determination part determines that the driver condition of said another vehicle is not acceptable.

2. The vehicle peripheral monitoring apparatus according to claim 1, comprising:
a receiver configured to receive, from outside, an autonomous driving guideline in which the autonomous driving level and the acceptable driver condition are associated with each other when the subject vehicle starts,
wherein the storage stores the autonomous driving guideline received by the receiver.

3. The vehicle peripheral monitoring apparatus according to claim 1, wherein the autonomous driving level recognition part is configured to recognize the autonomous driving level of said another vehicle by acquiring the autonomous driving level of said another vehicle output from said another vehicle via vehicle-to-vehicle communication.

4. The vehicle peripheral monitoring apparatus according to claim 1, wherein the autonomous driving level recognition part is configured to recognize the autonomous driving level of said another vehicle by reading the autonomous driving level of said vehicle indicated in said another vehicle.

5. A vehicle peripheral monitoring method, comprising:
recognizing an autonomous driving level of another vehicle present around a subject vehicle;
acquiring a driver condition of said another vehicle;
storing autonomous driving levels and acceptable driver conditions in association with each other;
comparing the stored acceptable driver condition at the recognized autonomous driving level with the acquired driver condition of said another vehicle in order to determine whether or not the driver condition of said another vehicle is acceptable; and
notifying a warning to a driver of the subject vehicle when it is determined that the driver condition of said another vehicle is not acceptable.

6. The method according to claim 5, comprising:
receiving, from outside, an autonomous driving guideline in which the autonomous driving level and the acceptable driver condition are associated with each other when the subject vehicle starts, and
storing the received autonomous driving guideline.

7. The method according to claim 5, wherein the autonomous driving level of said another vehicle is recognized by acquiring the autonomous driving level of said another vehicle output from said another vehicle via vehicle-to-vehicle communication.

8. The method according to claim 5, wherein the autonomous driving level of said another vehicle is recognized by reading the autonomous driving level of said vehicle indicated in said another vehicle.
